(19) United States
(12) Patent Application Publication
(10) Pub. No.: US 2006/0274295 A1
(43) Pub. Date: Dec. 7, 2006

(54) Nanotool processes and applications

(76) Inventors: Steven R. J. Brueck, Albuquerque, NM (US); Alex Raub, Albuquerque, NM (US)

Correspondence Address: MIN, HSIEH & HACK LLP, 8270 GREENSBORO DRIVE, SUITE 630, MCLEAN, VA, 22102, US

(21) Appl. No.: 11/417,031

(22) Filed: May 4, 2006

Related U.S. Application Data
(60) Provisional application No. 60/677,331, filed on May 4, 2005.
(60) Provisional application No. 60/680,540, filed on May 13, 2005.

(51) Int. Cl. G03B 27/54

(52) U.S. Cl. 355/67

(57) ABSTRACT

In accordance with the invention, there are processes for creating nanostructures using interferometric lithography, and apparatus and methods for conducting interferometric lithography. The apparatus can include a light source that provides an input beam characterized by both a transverse and a longitudinal coherence length, an optical arrangement for splitting the input beam in into a first beam and a second beam, wherein the first beam and the second beam each fold onto each other, and a target including a top surface, wherein the target is disposed such that an interferometric pattern is formed by the first beam and the second beam on the top surface. The apparatus can also include a prism disposed in an optical path of the first beam and an optical path of the second beam, and an immersion liquid disposed over the target and forming a continuous optical element between the prism and the target.

### CROSS-REFERENCE TO RELATED APPLICATIONS

This application claims priority to U.S. Provisional Patent Applications Ser. No. 60/677,331 filed on May 4, 2005 and Ser. No. 60/680,540 filed on May 13, 2005, the disclosures of which are incorporated by reference herein in their entirety.

### FIELD OF THE INVENTION

The subject matter of this invention relates to immersion interferometric lithography. More particularly, the subject matter of this invention relates to the use of excimer lasers for immersion interferometric lithography for fabrication of nanoscale structures.

### BACKGROUND OF THE INVENTION

Optical lithography is a well-established technique in the fabrication of semiconductor devices. As semiconductor devices have continued to shrink in size, alternative lithographic technologies have been explored, including electron beam, x-ray, and ion-beam. Each of these techniques has advantages and disadvantages. Electron beam lithography can produce structures at scales smaller than optical lithography and with complete pattern flexibility (within the limits imposed by proximity effects). In electron beam lithography, the beam is scanned across the surface to be patterned. The serial pattern generation in electron beam lithography makes it unsuitable where large area nano-patterning is required, as in volume manufacturing. On the other hand, optical lithography is a parallel technique, in which a large number of pixels are patterned at once. Traditional optical lithography uses a mask-based approach along with optical reduction to meet the demands of both the mask fabrication and the optical system.

Interferometric lithography based on the interference of two or more coherent laser beams can produce useful patterns over large two-dimensional areas and three-dimensional volumes. Interferometric lithography can produce patterns approaching 20 nm in scale with considerable but not total pattern flexibility. In conventional interferometric lithography, a simple corner cube arrangement is often used where the right and left halves of the beam are folded onto each other using a 90° geometry. This arrangement has been used successfully with laser sources having a high transverse coherence such as single mode TEM₀₀ Ar-ion laser beams. However excimer lasers exhibit a large number of transverse modes and consequently a very low transverse coherence. Hence, the conventional interferometric lithography arrangement is not suitable, since the two halves of the beam are not, in general, mutually coherent.

Accordingly, there is a need for apparatus and methods for conducting interferometric lithography that provides an inexpensive, large area capability. Further by using multiple exposures, multiple beams, and mix and match with other lithographies, one can extend the range of applicability of these apparatus and methods.

### SUMMARY OF THE INVENTION

In accordance with the invention, there is an apparatus for interferometric lithography. The apparatus can include a light source that provides an input beam characterized by both a longitudinal and a transverse coherence length, an optical arrangement for splitting the input beam in into a first beam and a second beam, wherein the first beam and the second beam each fold onto each other within these transverse and longitudinal coherence lengths, and a target comprising a top surface, wherein the target is disposed such that an interferometric pattern is formed by the first beam and the second beam on the top surface. The apparatus can include a prism disposed in an optical path of the first beam and an optical path of the second beam. The apparatus can also include an immersion liquid disposed over the target and forming a continuous optical element between the prism and the target.

According to another embodiment of the present invention there is a method for conducting interferometric lithography The method can include providing a light source beam that provides an input beam characterized by both a transverse and a longitudinal coherence length, providing an optical arrangement for splitting the input beam in into a first beam and a second beam, wherein the first beam and the second beam each fold onto each other within these transverse and longitudinal coherence lengths, providing a target comprising a top surface, wherein the target is disposed such that an interferometric pattern is formed by the first beam and the second beam on the top surface. The method can include providing a prism disposed in an optical path of the first beam and an optical path of the second beam. The method can also include providing an immersion liquid disposed over the target and forming a continuous optical element between the prism and the target.

According to yet another embodiment of the present invention, there is a process for creating nanostructures at a smaller scale using spatial period division. The process can include making a first pattern on a first layer of photoresist atop a sacrificial layer on a substrate using immersion interferometric lithography and transferring the first pattern onto the sacrificial layer. The process can also include depositing a second layer of photoresist over the sacrificial layer, making a second pattern on the second layer of photoresist using immersion interferometric lithography, but shifted by λ/4 NA, and transferring the second pattern onto the sacrificial layer. The process can further include transferring the first and second composite pattern onto the substrate. The process can also include a saturable absorber layer over the photoresist layer.

In accordance to various embodiments, a process for creating nanostructures using spatial frequency multiplication can comprise making a first pattern on a first layer of photoresist atop a sacrificial layer on a substrate using immersion interferometric lithography, transferring the first pattern onto the sacrificial layer, depositing a second layer of photoresist over the sacrificial layer. The process can also include making a second pattern on the second layer of photoresist using immersion interferometric lithography, but shifted by λ/2mNA, where m is an integer, transferring the second pattern onto the sacrificial layer, depositing a third layer of photoresist over the sacrificial layer, making a third pattern on the third layer of photoresist using immersion interferometric lithography, but shifted by an additional λ/2mN, and transferring the third pattern onto the sacrificial layer, and repeating this process up to an m^{th} layer. Transferring the first, second, third, and subsequent pattern onto the substrate giving a spatial frequency multiplication by a factor of m.

Additional advantages of the embodiments will be set forth in part in the description which follows, and in part will be obvious from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is a schematic illustration of an apparatus for carrying out interferometric lithography according to various embodiment of the present invention.

FIG. 2 is a schematic illustration of an exemplary apparatus for carrying out immersion interferometric lithography according to various embodiments of the present invention.

FIG. 3 shows a simple calculation of the fringe visibility for immersion lithography at 193 nm using Water as an immersion liquid and transverse magnetic polarization.

FIGS. 4A to 4E illustrate an exemplary process for creating a nanostructure using spatial period division in accordance with various embodiments of the present invention.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g.−1, −2, −3, −10, −20, −30, etc.

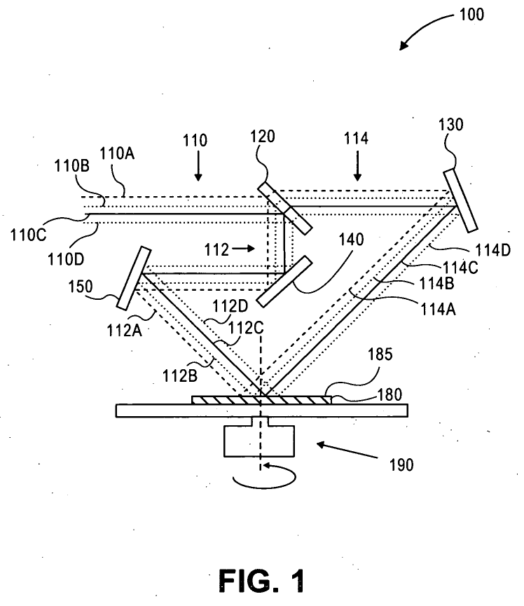

FIG. 1 is a schematic illustration of an exemplary apparatus 100, for carrying out interferometric lithography. The exemplary interferometric lithography apparatus 100 can include an input beam 110 and an optical arrangement for splitting the input beam 110 into a first beam 112 and a second beam 114, wherein the first beam 112 and the second beam 114 each fold onto each other within a transverse coherence length and a longitudinal coherence length. The interferometric lithography arrangement 100 can further include a target 180 comprising a top surface 185, wherein the target 180 is disposed such that an interferometric pattern is formed by the first beam 112 and the second beam 114 on the top surface 185 of the target 180. The target 180 can also be placed on a rotation stage 190.

According to various embodiments of the present invention, the target 180 on the rotation stage 190 can be rotated to align the interferometric lithography pattern to be formed to a feature on the substrate, such as, for example, a crystal direction. In certain embodiments, the target 180 on the rotation stage 190 can be rotated to produce 2D (two dimensional) and 3D (three dimensional) patterns using multiple exposures.

Lithography refers to processes for defining a pattern on the top surface of the target. Furthermore, interference refers to the resultant wave pattern as a result of superposition of two or more coherent waves that oscillate with a well-defined, time-invarient phase difference over the duration of the exposure. Hence, in interferometric lithography, two or more coherent optical beams incident from different directions on a two-dimensional (thin photosensitive film with thickness <<λ) or three-dimensional (thick photosensitive film with thickness >>λ) are used to produce an interference pattern whose intensity distribution is recorded in the photosensitive layer. The interference pattern is later transferred (developed) by thermal and or chemical processes. The photosensitive material can be a photoresist or any other material capable of undergoing a substantive change upon exposure to optical radiation, where the optical radiation can be pulsed or continuous. The change typically induced is a modulation of the dissolution rate in a chemical developer that depends in a complex, nonlinear way on the local irradiance during the exposure.

In two beam interference, two coherent optical plane waves with the same polarization symmetrically incident on a photosensitive layer at angle of θ, produce an intensity pattern in space given by:

$$\begin{matrix}I ( x , z ) = {\vert E \vert}^{2} {\vert {\hat{e}}_{1} {ⅇ}^{ⅈkx sin θ} + {\hat{e}}_{2} {ⅇ}^{- ⅈkx sin θ} \vert}^{2} \\ = {\vert E \vert}^{2} [ 2 + ( {\hat{e}}_{1} \cdot {\hat{e}}_{2}^{*} {e}^{ikx sin θ} + {\hat{e}}_{1}^{*} \cdot {\hat{e}}_{2} {ⅇ}^{- ⅈkx sin θ} ) ] \\ = 2 {\vert E \vert}^{2} [ 1 + {σ}_{pol} cos ( 2 kx sin θ ) ]\end{matrix}$$

where k=2πn/λ with n the refractive index of the incident medium directly adjacent to the surface layer (1 for air) and λ the optical wavelength, êᵢ is the unit polarization vector for each wave, and σₚₒₗ=[1, cos(2θ)] for (TE—transverse electric, TM—transverse magnetic) polarization with σ_{TE}=1 and σ_{TM}=cos(2θ). The period of the interference pattern along the x-direction is given by λ/[2n sin θ]. By Snell's law, this period is invariant across any layer boundaries parallel to the top surface 185 of the target 180; this invariance is not true for the contrast. The top surface 185 of the target 180 can be a lithography stack and can include various chemical and optically functional thin films such as a protective top coat and a bottom antireflective layer. TE polarization always gives the maximum contrast, while the contrast is reduced for TM polarization as a result of the π-phase shift between the êₓ and ê_{z} contributions to the interference intensity. For the evaluation of polarization dependence, it is important to use the propagation angles inside the photosensitive layer. The contrast reduction for TM polarization becomes significant for steep angles in the photosensitive layer. For n=1, at angle of incidence of 75°, sin θ˜1 (=0.97), therefore the limiting period of interferometric lithography is ≧λ/2 and extends below 100 nm at a wavelength of 193 nm.

Referring again to FIG. 1, the exemplary apparatus for interferometric lithography 100 can include an input beam 110. The input beam 110, shown for the purpose of illustration, can include four representative rays 110a, 110b, 110c, and 110d, each identified on the figure by a different line style (dashed, dotted, solid, dotted, respectively). The input beam 110 can be split by a beam splitter 120 into two beams, a first beam 112, including four representative rays 112a, 112b, 112c, and 112d and a second beam 114, including four representative rays 114a, 114b, 114c, and 114d; in the figure the corresponding line styles have been retained for each ray. The optical arrangement 100 can include optics 130 for reflecting the beam 114. The arrangement 100 can further include optics 140 and 150 to direct the second beam 112, such that the angular relationship between the rays and the normal to the sample surface are approximately equal and a path length of the first beam 112 and the second beam 114 between the beam splitter and the sample are approximately equal.

In certain embodiments, the first beam 112 and the second beam 114 fold onto each other within the transverse and longitudinal coherence lengths. As used herein, the term “fold onto each other” refers to, for example, the ray 112a of the first beam 112 overlapping with the ray 114a of the second beam 114, ray 112b overlapping with the ray 114b, ray 112c overlapping with the ray 114c, and ray 112d overlapping with the ray 114d on the top surface 185 of the target 180 where an interferometric pattern is formed. The requirement that the first beam 112 and the second beam 114 fold onto each other within a transverse coherence length and a longitudinal coherence length results in the requirement that the input beam 110 has narrow spectral width with respect to the inverse of the optical path length difference of the respective rays of beam 112 and 114 across the top surface 185 and hence significant coherence. In certain embodiments, the input beam 110 can have a very narrow line-width, linewidth<<1 pm and longitudinal coherence length of ˜λ²/Δλ≧4 cm.

According to various embodiments, the beam splitter 120 can be a grating beam splitter. A grating beam splitter 120 can provide the necessary angular relationship of the first beam 112 and second beam 114 and also equal path lengths to provide self coherence across the pattern area 185 of the target 180. In accordance with other embodiments, a phase grating 120 can be optimized to result in maximum coupling into the ±1 diffraction orders. These two orders can then be recombined either with a second grating or with a pair of mirrors 140 and 150 to provide the aerial image pattern.

In various embodiments, the input beam 110 can be provided by a light source such as an Argon Fluoride (ArF) excimer laser. In certain embodiments, the top surface 185 of the target 180 can include a photoresist disposed over a substrate. In other embodiments, additional thin film layers with various functionalities can be added to the photoresist, to protect the resist (e.g. a top coat layer); to enhance the transferability of the resultant pattern (a so-called hard mask layer); and to reduce reflection effects (both top and bottom anti-reflective layers are commonly used.)

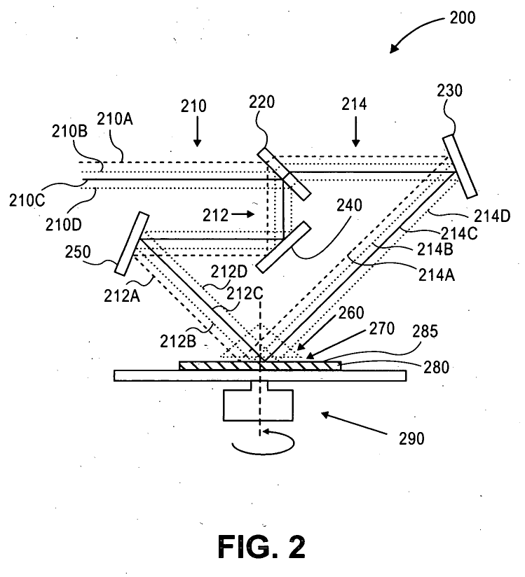

According to various embodiments, FIG. 2 illustrates an apparatus 200 for immersion interferometric lithography. The apparatus 200 for immersion interferometric lithography can include an input beam 210 and an optical arrangement for splitting the input beam 210 into a first beam 212 and a second beam 214, wherein the first beam 212 and the second beam 214 each fold onto each other within a transverse coherence length and a longitudinal coherence length. The apparatus 200 can also include a target 280 comprising a top surface 285, wherein the target 280 is disposed such that an interferometric pattern is formed by the first beam 212 and the second beam 214 on the top surface 285 of the target 280. The apparatus 200 can also include a prism 260 disposed in an optical path of the first beam 112 and second beam 114. The apparatus 200 can further include an immersion liquid 270 disposed over the target 280. In certain embodiments, the immersion liquid 270 contacts the prism 260 and the top surface 285 of the target 280. The presence of immersion liquid 270 between the prism 260 and the top surface 285 of the target 280 increases the optical resolution of the patterning process by a factor of the refractive index of the immersion liquid 270. In various embodiments, water with a refractive index of about 1.44 at 193 nm can be used as an immersion liquid 270.

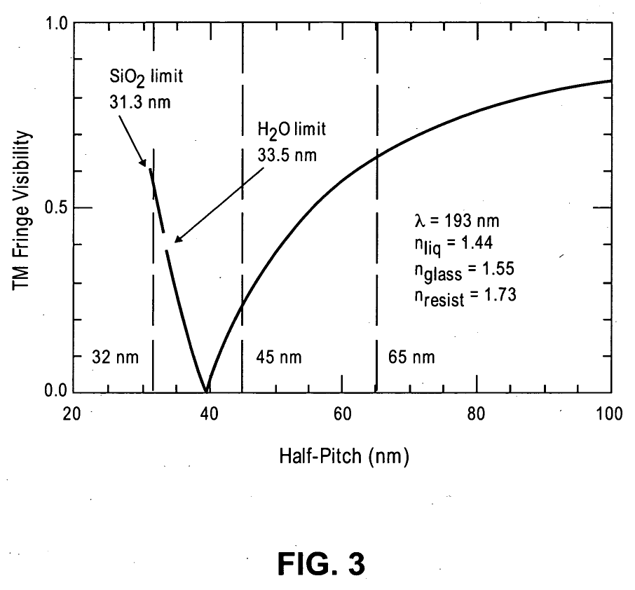

FIG. 3 shows a simple calculation of the fringe visibility for immersion lithography using water as an immersion liquid and 193 nm as the exposure wavelength. In immersion lithography, polarization is an important parameter at steep angles in the photoresist. For TE polarization, the fringe visibility [(Iₘₐₓ−Iₘᵢₙ)/(Iₘₐₓ+Iₘᵢₙ)] is unity independent of the half pitch. However for TM polarization, the fringe visibility decreases as the half pitch is decreased as a result of competition between the out of phase Eₓ² and E_{z}² contributions to the intensity. At an interference angle of 45° in the photoresist, these two terms are equal and opposite in phase and the visibility goes to zero. For larger interference angles, the line-space pattern is inverted, that is the lines become spaces and vice versa equivalent to a shift of the pattern by ½ the period. In FIG. 3, the cusp ˜40 nm corresponds to the inversion of the pattern—the interchange of lines and spaces. The minimum half pitch available with a 193 nm source and water as the immersion liquid is 33.5 nm. If a higher index liquid is available, the glass of the lens sets the limit at 31.3 nm. With a higher index glass as the final lens element, smaller half pitch patterns can be generated. Accordingly, the reduction in the fringe contrast and the line:space inversion require some form of polarization control for imaging the small half pitch patterns.

Turning now to the method for conducting interference lithography. The method can include providing a light source that provides an input beam 210, said light source characterized by both a longitudinal and a transverse coherence length, providing an optical arrangement 200 for splitting the input beam 210 in into a first beam 212 and a second beam 214, wherein the first beam 212 and the second beam 214 each fold onto each other within a transverse coherence length and a longitudinal coherence length. The method can further include providing a target 280 comprising a top surface 285, wherein the target 280 is disposed such that an interferometric pattern is formed by the first beam 212 and the second beam 214 on the top surface 285. The top surface 285 can be a photoresist layer on a substrate. The method can also include providing a prism 260 disposed in an optical path of the first beam 212 and in an optical path of the second beam 214. In another embodiment of the present invention, the method can include providing an immersion liquid 270 disposed over the target 280. In certain embodiments, the method can further include providing an immersion liquid 270 in contact with the prism 260 and the top surface 285 of the target 280.

According to various embodiments, the method for conducting interference lithography can include placing the target 180 on a rotation stage 190, rotating the target 180 to align the interferometric lithography pattern to be formed to a feature on the substrate, such as crystal direction. In other embodiments, the method can also include rotating the target 180 on the rotation stage to produce 2D (two dimensional) and 3D (three dimensional) patterns using multiple exposures.

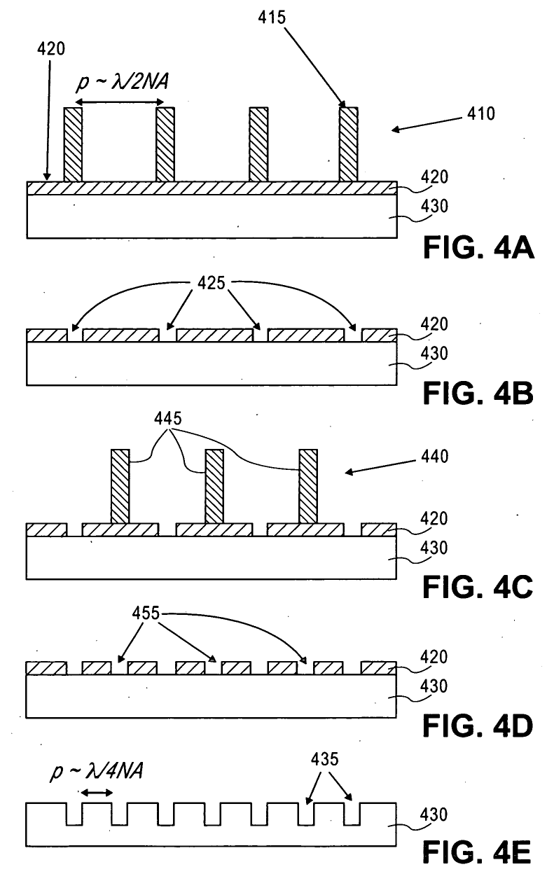

FIGS. 4A to 4E illustrates exemplary process for creating nanostructures using spatial period division in accordance with various embodiments of the present teachings. In spatial period division or spatial frequency multiplication, the nonlinearities in the exposure, development, and processing can be used to increase the pattern density. In certain embodiments, nonlinearities can be applied between exposure steps and images can be combined in such a way as to reduce or eliminate the lower frequency components and thereby leaving the higher density of structures.

Referring to FIG. 4A, a process for creating nanostructures using spatial period division includes making a first pattern 415 on a first layer of photoresist 410 atop a sacrificial layer 420 on a substrate 430 using immersion interferometric lithography. The sacrificial layer 420 can be photoresist. The period of the interferometric lithography pattern 415 is limited by the optics to around λ/2 NA. The CD (critical dimension) is not limited by the optics and can be chosen to be less than λ/8 NA.

The process for creating nanostructures can include transferring the first pattern 415 onto the sacrificial layer 420 as illustrated in FIG. 4B. In FIG. 4B, the transferred pattern 425 onto sacrificial layer 420 can be fabricated by etching process. One of ordinary skill in the art would know that the etching includes, but is not limited to, chemical, plasma, physical (ion milling), and reactive ion etching. The process can further include depositing a second layer of photoresist 440 over the sacrificial layer 420 and making a second pattern 445 on the second layer of photoresist 440 using immersion interferometric lithography, but shifted by λ/4 NA. FIG. 4C shows the second pattern 445 shifted by phase λ/4 NA with respect to the pattern 415 and the pattern 425 on the sacrificial layer 420.

FIG. 4D shows that the process for creating nanostructures can further include transferring the second pattern 445 onto the sacrificial layer 420. The second pattern 455 onto the sacrificial layer 420 is shown in FIG. 4D. FIG. 4E shows that the process of fabricating nanostructures can also include transferring the first 425 and second 455 composite pattern 435 onto the substrate 430. Hence, as shown in FIG. 4E, the final pattern 435 at period of λ/4 NA can be twice as dense as the single exposure optical limit λ/2 NA.

The nonlinearities in the process give rise to harmonics of the fundamental frequency in the exposure—which is limited to 2n/λ by the low-frequency bandpass characteristics of optics. For a square wave resulting from the nonlinearity, the resultant exposure as a result of spatial frequency multiplication is given by:

$$\begin{matrix}T ( x ) = N [ {I}_{1} ( x ) ] ⊗ N [ {I}_{2} ( x ) ] \\ = \frac{a}{2} \{ {\sum }_{l} \frac{sin ( \frac{2 π {lNA}_{a}}{λ} )}{\frac{2 π {lNA}_{a}}{λ}} [ 1 + {( - 1 )}^{l} ] \} {ⅇ}^{ⅈ \frac{4 π lNA}{λ} x} \\ = a {\sum }_{l} \frac{sin ( \frac{2 π {lNA}_{a}}{λ} )}{\frac{2 π {lNA}_{a}}{λ}} {ⅇ}^{ⅈ \frac{8 π lNA}{λ} x}\end{matrix}$$

where T(x) is the resultant exposure, N[I₁(x)] & N[I₂(x)] are the nonlinearities in the first and second exposure. It is well known, that the Fourier series expansion of a square wave is the sinx/x as given in the above equation. The second exposure and nonlinearity also produce a square wave, but shifted by ½ the pitch. This gives rise to the factor of (−1) raised to the Ith power. The net result is that the even (I=0, 2, 4, 6, . . . ) terms reinforce and the odd terms (I=1, 3, 5, . . . ) cancel leaving a square wave at twice the original pitch or ½ the spacing. In the above equation for the resultant exposure. T(x), the operator between the two nonlinear exposures N[I₁(x)] & N[I₂(x)] can be other than simple addition. Other functionalities such as multiplication, subtraction, etc. can be envisioned with other process sequences. In the exemplary process for fabricating nanostructures, illustrated in FIG. 4A to 4E, the combination is simple addition. In another exemplary case, wherein the two resist layers 410 and 440 can be sensitive at different wavelengths, the combination can be multiplication. The p/4 shift of the second exposure results in a factor of (−1)^{I} in the Fourier coefficients, with the net result that all of the odd terms cancel leaving a sin(x)/x pattern at twice the original pitch or half the period.

In various embodiments of the present invention, the spatial frequency multiplication can be applied to arbitrary patterns as well as to the periodic grating pattern. In certain embodiments, the process can be repeated multiple times for integer spatial frequency multiplications: 3, 4, . . .

While the description of spatial frequency multiplication provided above is presented in terms of a sacrificial layer with process steps between the two exposures (developing the resist, transferring the resist pattern into the sacrificial layer and recoating a second photoresist layer), other approaches to applying the nonlinearity, such as the use of a saturable absorber layer atop the photosensitive material, can be used alternatively and equivalently. The advantage of using a saturable absorber layer is that the wafer does not have to be removed from the exposure system between exposures allowing a higher throughput.

As disclosed herein, immersion interferometric lithography can be a parallel optical process that is scalable to full wafer areas. Further, interferometric lithography is maskless, and therefore changing pitch, aperture/period ratio, pattern symmetry can be rapid and inexpensive

Immersion interferometric lithography can be used in the areas of nanofluidics such as bio-nano interface separation and sequencing, switches—fluidic transistors, and lab on a chip. Interferometric lithography in the field of Plasmonics and Metamaterials provide new direction for infrared, enhanced detectors, and eliminate the need for phase matching in nonlinear optics. Interferometric lithography can be used to make masks for imprint lithography, photonic crystals for DFB lasers, tunable lasers for spectroscopy, and photonic crystals waveguide. Nonvolatile memory media such as hard disk drives can also benefit from segmentation of the magnetic media either into tracks or into individual domains; interferometric lithography (or immersion interferometric lithography) can also be applied to this large scale manufacturing requirement.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for interferometric lithography comprising:
a light source that provides an input beam characterized by both a transverse and a longitudinal coherence length;
an optical arrangement for splitting the input beam in into a first beam characterized by both a transverse and a longitudinal coherence length; beam and a second beam, wherein the first beam and the second beam each fold onto each other within these transverse and longitudinal coherence lengths; and
a target comprising a top surface, wherein the target is disposed such that an interferometric pattern is formed by the first beam and the second beam on the top surface.

2. The apparatus of claim 1, wherein the input beam has a linewidth of about less than 1 picometer and a longitudinal coherence of about λ²/Δλ≧4 cm.

3. The apparatus of claim 1, wherein the light source comprises an ArF excimer laser.

4. The apparatus of claim 1, wherein the light source comprises a KrF excimer laser.

5. The apparatus of claim 1, wherein the plurality of optics comprises a grating beam splitter.

6. The apparatus of claim 1, wherein the top surface of the target comprises a photoresist disposed over a substrate.

7. The apparatus of claim 6, wherein an angular relationship between each individual beam and a top surface of the photoresist, and path lengths of the first beam and the second beam from the beam splitting optics to the top surface of the photoresist are approximately equal.

8. The apparatus of claim 1, further comprising a prism disposed in an optical path of the first beam and an optical path of the second beam.

9. The apparatus of claim 1, further comprising an immersion liquid disposed over the target and forming a continuous optical element between the prism and the target.

10. A method for conducting interferometric lithography comprising:
providing a light source that provides an input beam beam characterized by both a transverse and a longitudinal coherence length;
providing an optical arrangement for splitting the input beam in into a first beam and a second beam, wherein the first beam and the second beam each fold onto itself within these transverse and a longitudinal coherence lengths;
providing a target comprising a top surface, wherein the target is disposed such that an interferometric pattern is formed by the first beam and the second beam on the top surface.

11. The method of claim 10, wherein the input beam has a line-width of about less than 1 picometer and a longitudinal coherence of about λ²/Δλ≧4 cm.

12. The method of claim 10, wherein the light source comprises an ArF excimer laser.

13. The method of claim 10, wherein the light source comprises a KrF excimer laser.

14. The method of claim 10, wherein the plurality of optics comprises a grating beam splitter.

15. The method of claim 10, wherein the top surface of the target comprises a photoresist disposed over a substrate.

16. The method of claim 15, wherein an angular relationship between each individual beam and the top surface of the photoresist, and path lengths of the first beam and the second beam from the beam splitting optics to the top surface of the photoresist are approximately equal.

17. The method of claim 10, further comprising a prism disposed in an optical path of the first beam and an optical path of the second beam.

18. The method of claim 11, further comprising an immersion liquid disposed over the target and forming a continuous optical element between the prism and the target.

19. A process for creating nanostructures using spatial period division comprising:
making a first pattern on a first layer of photoresist atop a sacrificial layer on a substrate using immersion interferometric lithography;
transferring the first pattern onto the sacrificial layer;
depositing a second layer of photoresist over the sacrificial layer;
making a second pattern on the second layer of photoresist using immersion interferometric lithography, but shifted by λ/4 NA;
transferring the second pattern onto the sacrificial layer; and
transferring the first and second composite pattern onto the substrate.

20. The process of claim 19, wherein the immersion interferometric lithography is carried out using ArF excimer laser.

21. The process of claim 19, wherein the immersion interferometric lithography is carried out using KrF excimer laser.

22. The process of claim 19, wherein the line width of the first pattern is less than p/4 with p being the pitch.

23. The process of claim 19, wherein the composite pattern results has a spatial frequency doubled pattern at p/2, with π˜λ/4 NA.

24. The process of claim 19, wherein there is a saturable absorber layer over the photosensitive material.

25. A process for creating nanostructures using spatial frequency multiplication comprising:
making a first pattern on a first layer of photoresist atop a sacrificial layer on a substrate using immersion interferometric lithography;
Transferring the first pattern onto the sacrificial layer;
depositing a second layer of photoresist over the sacrificial layer;
making a second pattern on the second layer of photoresist using immersion interferometric lithography, but shifted by λ/2mNA, where m is an integer;
transferring the second pattern onto the sacrificial layer; and
repeating the above steps a total of m times.
